(19) United States
(12) Patent Application Publication
(10) Pub. No.: US 2015/0076281 A1
(43) Pub. Date: Mar. 19, 2015

(54) NEUTRAL BUOYANCY CRAFT

(71) Applicant: LASKARRI LIMITED, London (GB)

(72) Inventor: Stylianos Laskaris, Kifisia (GR)

(73) Assignee: LASKARRI LIMITED, LONDON (GB)

(21) Appl. No.: 14/397,166

(22) PCT Filed: Apr. 24, 2013
(86) PCT No.: PCT/GR2013/000026

§ 371 Date: Oct. 24, 2014

(30) Foreign Application Priority Data
Apr. 24, 2012 (GR) 201201100226

(51) Int. Cl. B64B 1/36; G05D 1/08; B64B 1/12; B63G 8/00; G05D 1/00

(52) U.S. Cl. CPC B64B 1/36; B63G 8/00; G05D 1/00; B64B 1/12; G05D 1/08
USPC 244/96

(57) ABSTRACT

Neutral buoyancy craft of architecture according to which all the necessary for its guidance, navigation and control forces act exclusively on part A (2.1) which locates between the craft's extreme front and the Drag's application center D as the surrounding flow's axis is parallel to the craft's longitudinal axis and its direction from its front portion towards its back. The part A (2.1) which may be an independent part connected to the rest of the craft by means that ensure the effective transfer of powers from the one part to the other allowing also the relative rotation between the two parts by 360 degrees around the craft's longitudinal axis.

The present application refers to neutral buoyancy crafts meaning crafts to which lift is provided from a fluid of lower density than the environment's, stored in suitable premises within their halls, of which the guidance, navigation and control, further in the document and in terms of abbreviation will be referred as GN&C, into the environmental fluid is accomplished with the use of thrust and movable surfaces. Airships and submarines are characterized as crafts of neutral buoyancy. The present application's proposed architecture is applicable in both the above mentioned craft types and concerns architecture regarding the application center of thrust and control forces and systems through which the above mentioned forces are transferred to the craft. In the present application are also presented the method through which a craft's, of the above mentioned architecture, GN&C are achieved as well as a method of the crafts hull's orientation by 360 degrees over the pitch and roll axes exclusively applicable on a craft of the present application's proposed architecture.

The world's first ever study on advancing/directing an air craft, whose buoyancy was provided by a gas lighter than air, was presented on December third of the year 1783 by Jean Baptiste Marie Meusnier to the French Academy. The first airship powered flight was accomplished by Henri Giffard in the year 1852.

Up until today there have also been proposed or built airships of various classes relating to thrust's application center position as well as the navigation control of which the main ones are:

1. Airships with the thrust application center locating closer towards the craft's front section than the drags application center. The application centers of mass, thrust and lift do not coincide with the axis defined by the drag. The crafts GN&C are achieved by moving spoilers mounted on stabilizing fins located at the rear of the craft. Crafts of this class will be referred below as crafts of class 1.
2. Airships with the thrust application center located closer towards the craft's front section than the drags application center as well as closer towards the center of lift and the axis defined by the drag's direction than the craft's center of mass. The craft's GN&C are achieved by moving spoilers mounted on stabilizing fins located at the rear of the craft. Crafts of this class will be referred below as crafts of class 2.
3. Airships on which the thrust application center locates closer towards the craft's front portion than the drag's application center. The thrust application center also coincides with the axis defined by the drag's direction. The crafts GN&C are achieved by moving spoilers mounted on stabilizing fins located at the rear of the craft. Crafts of this class will be referred below as crafts of class 3.
4. Airships with the thrust application center locating closer than the drags application center towards the craft's stern. The thrust application point coincides with the craft's longitudinal axis and that is provided by one unit. The crafts GN&C are achieved by moving spoilers mounted on stabilizing fins locating at the rear of the craft. Crafts of this class will be referred below as crafts of class 4.
5. Airships with the thrust application center locating closer than the drags application center towards the stern. The thrust application center coincides with the envelope's longitudinal axis and is provided by one unit. The crafts stability is achieved through stabilizing fins located at the rear of the craft and the GN&C through thrust vectoring. Crafts of this class will be referred below as crafts of class 5 in which we may rank the following: Inventor GEERY DANIEL, title “Highly maneuverable powered airship”, number US2005263642, and filing date 2004 Nov. 4.
6. Airship with the thrust application center locating closer to the application centers of gravity, lift and drag towards the rear portion of the craft. The stability and GN&C is achieved through changing of the angle or the level of the thrust provided by thrust systems located at the craft's rear portion. Crafts of this class will be referred below as crafts of class 6 in which we may rank the following: Inventor LEE YEE-CHUN, title “Boundary layer propulsion airship with related system & method”, number WO2009105160, filing date 2009 Feb. 6.
7. Airships propelled by several thrust units, which are located on either sides of the gondola at different locations along the craft's longitudinal axis. Crafts of this class will be referred below as crafts of class 7 in which we may rank the following: Inventors JOHN ENLOE BROYLES, HENRY EMMET ROBERTSON, and THEODORE HENRY WEILER, title Improvements in airships, application number GB250602, filing date 1926 Apr. 8.
8. Airships promoted by several units, which in groups each one of which the resultants thrust force's application centers are located on different positions along the craft's longitudinal axis. The craft's stability and GN&C is achieved solely by changing the relation of the size as well as the angle of the generated thrust. This makes unnecessary the use of fins for the stabilization and control with benefits under certain conditions over the craft's handling at very low or nonexistent flow around it. Crafts of this class will be referred below as crafts of class 8 in which we may rank the following: Inventor Nagy Imre, title “High speed airship”, number WO2005019025, and filing date 2003 Aug. 15.
9. Airships of which the thrust's application center is located closer to the application center of drag towards the crafts front portion as well as in position coincident with the drag's axis with which the center of lift is also coincident. The stability is provided by fins which are located in the rear part of the craft. The directional control normal to the level set by the craft's longitudinal axis and the thrust application points is achieved through providing more thrust from one of the two units while in the plane vertically intersected by the above mentioned through the direction change of the thrust provided by the units. Crafts of this class will be referred below as crafts of class 9 in which we may rank the following: Inventor Krause Tomas, title “Airship”, number WO2008110385 and filing date 2008 Mar. 17.
10. Airships propelled by one thrust unit which is located at the extreme front in such a way that the provided thrust's axis coincides with the crafts longitudinal axis. Control and stability are carried out by fins located on the crafts rear portion. Crafts of this class will be referred below as crafts of class 10 in which we may rank the following: Inventor, PHILIPPE AUGUSTE, title “Improvements in connection with Dirigible Balloons” number GB191116635A, filing date 1911 Jul. 19.
11. Airships propelled by two thrust units located at the front end and the rear end portion in such a way that the axis of each thrust's unit direction coincides with the crafts longitudinal axis directed by a change of direction of one or both of the units or by fins adapted to the craft's back portion. Crafts of this class will be referred below as crafts of class 11. Crafts of this class will be referred below as crafts of class 11 in which we may rank the following: Inventor BRIX WOLFGANG, title “Propeller driven dirigible has steerable propellers on each end to aid maneuvering”, number DE10065385 (A1), date 2000 Dec. 27.
12. Airships propelled by two groups consisting of more than two units the one of each locates in the front end and the other in the rear end in such a way that the axis of the resultant of the thrust provided coincides with the craft's longitudinal axis. The stabilization and GN&C ensured through thrust vectoring. Crafts of this class will be referred below as crafts of class 12 in which we may rank the following: Inventor Voorhees Michael Todd, title “Differential Thrust Control System”, filing number US 2009127385 and filing date 2008 May 6.

Crafts that have been presented so far have the following attributes and limitations which under certain conditions related to the mission of the craft may be identified as disadvantages:

For crafts in classes 1, 2, we observe:

A. The thrust axis located at a distance from the drags application point results in the application of a torque force upon the craft during the application of the above mentioned forces. The torque force is centered on the line segment defined by the points of application. The above trend torque's direction is determined by the directions of the supplied thrusts and the axis of drag. The torque force's level depends on the following:
The level of the provided thrust in relation to the drags force level.
The distance between the application points of the drag and the resultant of thrust forces.
The angle of the line segment is determined in relation to the axis of the Flow field forces craft.
The distance between the craft's center of gravity and the drag's application center normal to the.
The crafts total mass.
The angle between the line segment, defined by the craft's center of gravity and the drag's application center and the axis defined by the drag's direction.
   The above torque force tends to rotate the craft around the pitch axis. This has the effect of placing limits on the size of the maximum thrust provided and therefore the maximum attainable speed as the magnification of thrust is limited by the strength of the envelope against elastic deformation which lays upon:
The material used for its construction
The internal pressure in case of an airship without a frame
The envelope's shape
The craft's drag coefficient
   B. Given that the center of gravity is located away from the center of lift, a particular angle of the craft around the roll axis is determined.
   C. In addition to the direction changes normal to yaw axis under the influence of the centrifugal force of its mass the craft tends to rotate around its longitudinal axis.

Regarding the crafts of classes 1, 2, 3, 4, 5 whose angle at the axes pitch, yaw and roll is determined exclusively through fins we observe:

A. Fins may be effective only when their surrounding flow is of a satisfactory speed.
B. The fins as well as the necessary adapting systems to the hull of the craft charge with their mass, the total mass of the craft.
C. The design of fins and their attachment systems require large part of the overall design time and testing a craft before production.
D. The fins and systems through which they are adapting to the craft's hull contribute greatly to the size of the craft's drag coefficient. Their contribution is magnified in lateral flow phenomena contributing to the extent deduction from the desired path and the difficulty of the craft's handling on the ground.

For crafts of classes 5 and 6, we observe all the above mentioned for categories 1, 2, 3, 4, 5 plus the following:

A. The maximum angle of provided thrust relative to the craft's longitudinal axis is 90 degrees; hence reversing thrust may be achieved solely by reversal of the rotation of the motor.
B. The thrust is acting on the craft's rear portion behind drag's application center, a fact that makes the craft unstable. These results in greater flexibility opposed to the required continuous fine-tuning and adjustments for its handling.
C. Under the influence of crosswinds large amounts of energy are required in combination with fine-tuning in order for the craft to maintain the desired course overcoming the effects of the wind. For this reason a company which undertook the development, production and sale of a craft of this category resulted in the solution of the adjustment to the front of the craft of a tilting thrust system in order through the class of directional thrust to enable effective control over the craft's direction with the disadvantage of charging aerodynamically the craft since the adopted front portion thrust system disturbs the craft's aerodynamic boundary layer.
D. The thrust and the Drag forces have a common axis with direction of each one towards the other, a fact which results in the exercise of forces that tend to push the crafts front and back portion towards its center. The result of the above mentioned on a type of craft which has no hard interior framework has the tendency of the envelope deforming, under the influence of opposing forces, thus with negative effects on aerodynamics, flight stability and safety of the craft. The size of the envelope's deformation lies in following three factors.
a. The magnitude of a craft's drag in relation to the size of the provided thrust.
b. The hardness of the crafts envelope, which for crafts with none internal metal or composite structure depends on the hardness of the material of construction in relation with the difference between the internal and the environmental fluids pressure.
c. The thrust's application center coincides with the axis of the craft while the center of gravity locates at a distance from it. In pursuit of these two forces on the craft is caused a torque force which is centered on the line segment defined by the above mentioned forces points of application. The above trend torque is detected at a level determined by the axis of the supplied thrust force and the craft's center of mass. The rotation around the pitch axis results from the supplied thrust's direction and the craft's inertia causing under the application of the above forces during acceleration the tendency of the craft to lower its nozzle. The effect's size depends on all of the following:
The magnitude of the thrust provided in relation to the size of the mass thereof.
The distance between the center of mass from the axis of thrust normal to the plane defined by them.
The angle of the line segment determined by the application centers of the above mentioned forces in relation to the axis of the craft.

For the crafts of classes 10, 11 the provision of thrust from one unit to the front end portion with axis coincident with the axis of the craft longitudinal results in the turbulent thrust flow to disturb the crafts boundary layer enlarging the craft's total fluidic resistance.

For crafts of all classes except the 10^{th} the smooth transfer of thrust, with the documentation of a flexible craft is essential in order to avoid elastic deformation of the craft's envelope in segments on which the forces of thrust are linked, one or the entire of the following are necessary:

A. Internal aid of airtight portions made from materials of higher strength and thus heavier over the material of the envelope of the craft in which gas is directed under pressure higher than that of the rest of the envelope.
B. Strengthening the construction materials of the envelope locally at the points of the drive units attachment.
C. The use of any kind of frame between the outer surface of the hull and the propulsion units.

The present patent application regards to architecture according to which all control forces apply exclusively in a part of the craft, which henceforth will be referred as part A, which is defined between the extreme front of the craft and the Drag's application center while the last is acting on the craft from the surrounding flow as the flow axis is parallel to the crafts longitudinal axis and its direction from the craft's front portion towards its stern. According to this application the part of the craft between the part A and the craft's back end below will be further referred as part B. The propulsion is ensured by a pair of thrust units disposed on opposite sides of the craft's longitudinal axis, the forces of which are transferred to the craft via connecting rods. The rods are part of a system which penetrates the segment (A) which is characterized by rigidity in order to effectively transmit all forces from systems fixed to each of the connecting rods towards the craft. The distance between the thrust units application points from the crafts longitudinal axis and their angular tilt in relation to it, are such that the thrust flow does not disturb the craft's boundary layer as the craft moves normal to a plane determined by its longitudinal axis and the direction of the surrounding flow as this plane is intersected perpendicularly from the line segment determined by the thrust application points towards their corresponding rods and also when the direction of the surrounding flow, the direction of the thrust forces and the crafts longitudinal axis are parallel. The above results, on the fact that during the provision of equal size of thrust by the thrust units as the resultant of the thrust forces is of direction opposite than of the drag's, only forces of tensile stress are transferred from part A towards the part B. The thrust forces are transferred to the craft through a connecting rod which penetrates the part A or via two connecting rods forming a system which penetrates the part A. In both cases, the above elements should according to the present application be characterized by rigidity of size such that to overcome the application of maximum thrust where appropriate from the thrust units at the point or points of the adjustment of A and B. Each of the two thrust units is possible in accordance with this application, be adapted to connecting rod through two different modes in such a way as to render assistance through servo possible change of the direction of thrust of each unit independently of the other, around the following two axes:

A. Axis which perpendicularly intersects the plane defined by the axis of the craft and the points of application of the thrust forces from the thrust units to the connecting rods.
B. Axis which coincides with the plane defined by the craft's longitudinal axis and the points of application of the thrust forces from the thrust units to the connecting rods.

Purpose of the above is to successfully control the craft' angles around the roll, pitch and yaw axes, by achieving an appropriate thrust angle, through the rotation of each power unit around the above designated axes.

On the rods that connect the thrust units to the craft, fins are suspended in such a way that through servomotors they may rotate about an axis which coincides with the longitudinal axis of their corresponding rod. The fins shall be designed to cover the rod and contribute to control the angle of roll through counter rotation and angle control in relation to the plane defined by the craft's longitudinal axis and the application points of thrust forces from the thrust units towards their corresponding rods via uni-rotation towards the wished direction. In order of the achievement of lower drag coefficient the fins may turn by their corresponding servomotors, in addition to the purpose of control, to rotate around the rod so that, in accordance with data collected from sensors over their angle of attack in respect with the surrounding flow and commands from computer management system of their corresponding servomotors, to occupy such positions as to present the least possible fluidic resistance. On each rod may suspend one or more fins. In the latter case one of the two fins on each side has a length and position such that its outer surface is exposed to the thrust flow while the other has a length and position such that its outer surface is exposed only to the surrounding free flow between the thrust flow and the craft's hull.

As all the forces by which stability and GN&C are ensured through elements of section A on the outer surface of Section B nothing that would support the craft's handling is attached. Also in Section B are not adjusted any thrust units through which would help the craft's control direction or ensuring its stability as well as to provide additional thrust to it.

The A section according to the present application can be an independent part from the rest of the craft (part B) and in this case the two parts are connected in such a way as to:

A. Ensure the stiffness of the connections between them in the exercise of all except rotational forces.
B. The ability of the relative rotation between them by 360 degrees around an axis which coincides with the axis of symmetry of the craft if its shape is symmetrical by revolution around its longitudinal axis or is parallel with the crafts longitudinal axis in any other case. The rotational angle/position of the parts between them, controlled by an actuator firmly fixed to one of the two parts of which rotational movement is transmitted through any transmission system, towards the other part.

The above operation results (when the part B is of a rotationally symmetric shape, the center of buoyancy and also the center of gravity coincides with its axis of symmetry and given that the control is accomplished solely by forces applying on part A to the applicability of the rotation around the roll axis of the part B without implying any impact over the craft's handling data. The purpose of the above function is the achievement of the appropriate position of part B and and systems firmly attached to it in directions along the craft's axis of roll over which they may become more efficient.

Exclusively to achieve proper orientation of the above systems in relation with the pitch axis within the part B in an appropriately structured base a load is suspended capable of moving along the longitudinal axis driven by a servo motor thus changing the craft's center of gravity resulting on the tuning of the craft's equilibrium state along the pitch axis. The corresponding servo motor receives signals from a computing unit, which is solely responsible for the tuning of the craft's equilibrium state normal to the pitch and roll axes for the purpose of also controls other systems on the craft that they are able to contribute to its purpose as the motor that controls the relative rotation between the parts A and B, the thrust units etc. with a view of more efficient operation of systems firmly attached on the part B.

A craft made in accordance with this application may move along a desired course according to its mission, keeping the crafts longitudinal axis for prolonged periods at an angle to its course as well as the horizon. This feature makes necessary any systems whose correct operation requires a certain angle relative to the horizon to be attached on the craft through bases that enable their proper orientation relative to the horizon or the craft's course.

A craft made according to the above mentioned characteristics presents against crafts of the present state of the art the following advantages:

1. By the provision from the thrust units of equally sized and thrust direction parallel with the axis of symmetry of the craft, the resultant thrust forces in the extreme forward portion of the craft to the point of application of which coincides with the axis of drag. This results in the performance of solely tensile forces above section B from the thrust since the only compression forces of the outer surface of section B derived exclusively from the surrounding flow. This feature makes possible the application of thrust of higher level in competence to crafts fabricated according to the state of the art.
2. Ability to build the hull using material of lower structural strength against those required to build similar sized crafts in accordance with the present state of the art with the following benefits:
A. Construction of the hull from materials of lower total weight.
B. Construction of hull from materials of lower total cost.
3. Smaller course deviation due to side flow effects in relation to the desired path as a consequence of the lower side projected area in the absence of fins attached to the back portion and the ability of the craft to move with the longitudinal axis at an angle in relation to the desired course such that it is displayed to the surrounding flow, the smallest possible area.
4. Efficient control of the craft in the entire range of the surrounding flow possible speeds.
5. Possibility of targeting the hull and hence firmly adapted on it systems about the axis of symmetry without any change of the crafts Drag as well as its stability and GN&C.
6. Chance of success orientation of craft and thus strongly adapted to this system on the transverse axis.
7. Ability of safer navigation than of crafts of the present state of the art into higher speed flow than of the highest possible attainable from the propulsion systems.
8. Ability of precise approach to attachment tower minimizing the need for ground personnel.
9. The absence of stability fins and the manufacturability of the hull from material of less strength/mass, results for a craft manufactured according to the present application a significant advantage in cases where the total mass of the craft and the low drag coefficient is critical for a mission such as accenting or leveling at high altitude.
10. The absence of stability fins and the possibility of constructing the hull of lower strength material/mass may be an advantage for a flexible airship in accordance with applications for which the low volume of the craft during storage and transportation is important.
11 Due to the absence of stability fins, it is possible for a craft of the present application to approach a tower with precision and pitch angles greater against crafts of the present state of the art.
12. Reason of the absence of stability fins and given that the fins automatically rotate the control to display the minimum possible surface area to the surrounding flow passage from the upper levels of the Troposphere and the Tropopause becomes safer for a craft constructed according to the present application, of which the official mission roof is at a greater height.
13. The required design time as well as the necessary testing of a craft of this application before it comes in production is reduced against crafts of the present state of the art.

A brief description of the attached figures follows.

FIG. 1 is a side view of a craft manufactured according to the present application as the axis defined by the thrust application points intersects perpendicularly the level of the horizon.

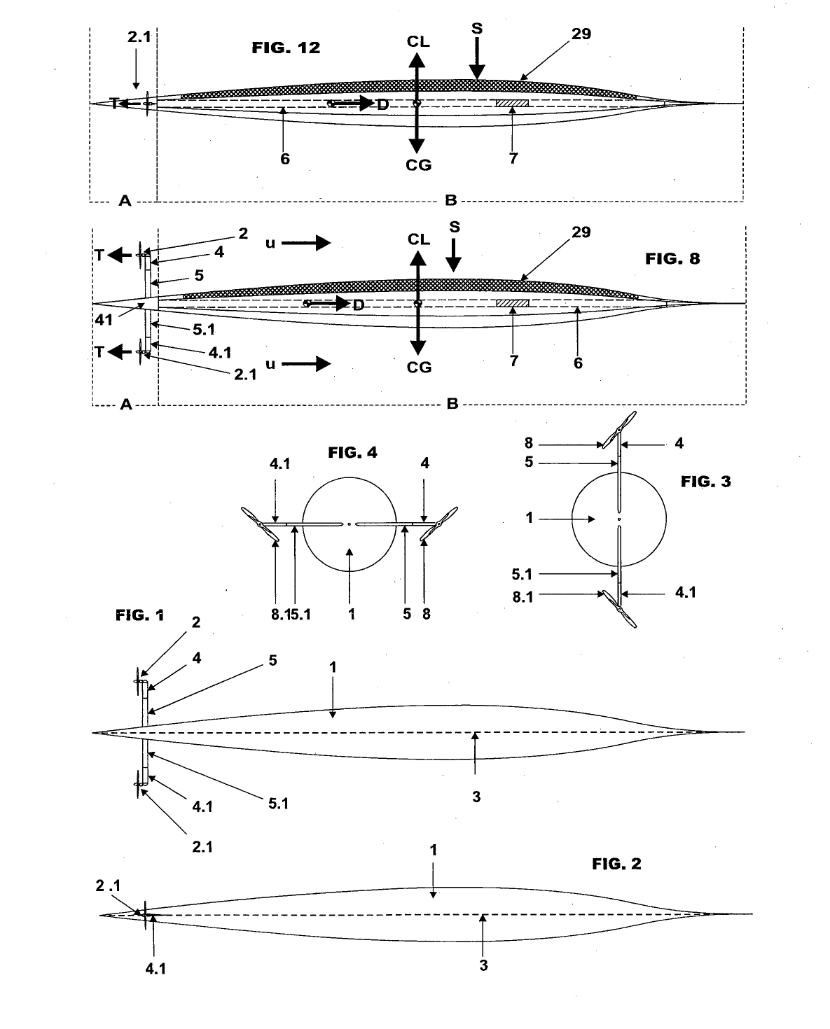

FIG. 2 is a side view of a craft manufactured according to the present application as the axis defined by the thrust application points is parallel with the level of the horizon.

FIG. 3 is a front view of a craft manufactured according to the present application as the axis defined by the thrust application points intersects perpendicularly the level of the horizon.

FIG. 4 is a front view of a craft manufactured according to the present application as the axis defined by the thrust application points is parallel with the level of the horizon.

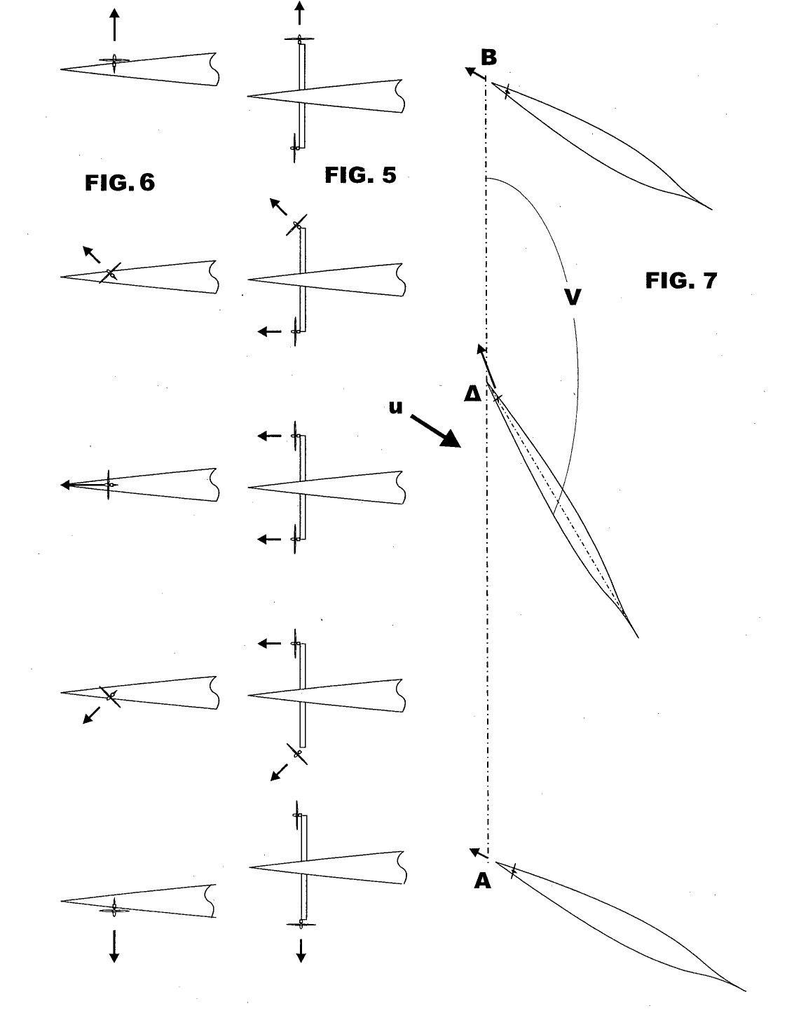

FIG. 5 presents a craft manufactured according to the present application as thrust is provided at various angles normal to the plane defined by the thrust application points and the crafts longitudinal axis.

FIG. 6 presents a craft manufactured according to the present application as thrust is provided at various angles around an axle defined by the thrust units application points.

FIG. 7 presents a craft moving between two points.

FIG. 8 presents in side view a craft that consists of two sections A, B with a solar array mounted on the outer surface of section B.

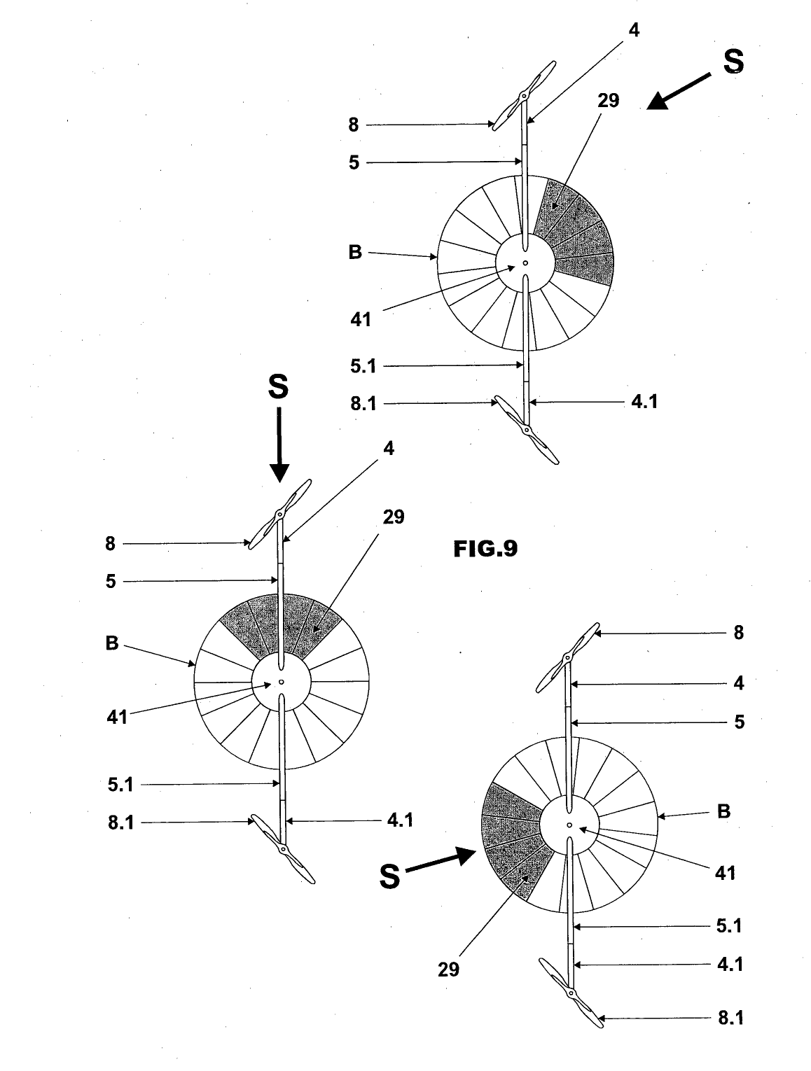

FIG. 9 presents the craft of FIG. 8 in three different front views in each one of which the section B has been rotated at different angles around the roll axis in order for the solar arrays mounted on its outer surface to be oriented towards the sun flux.

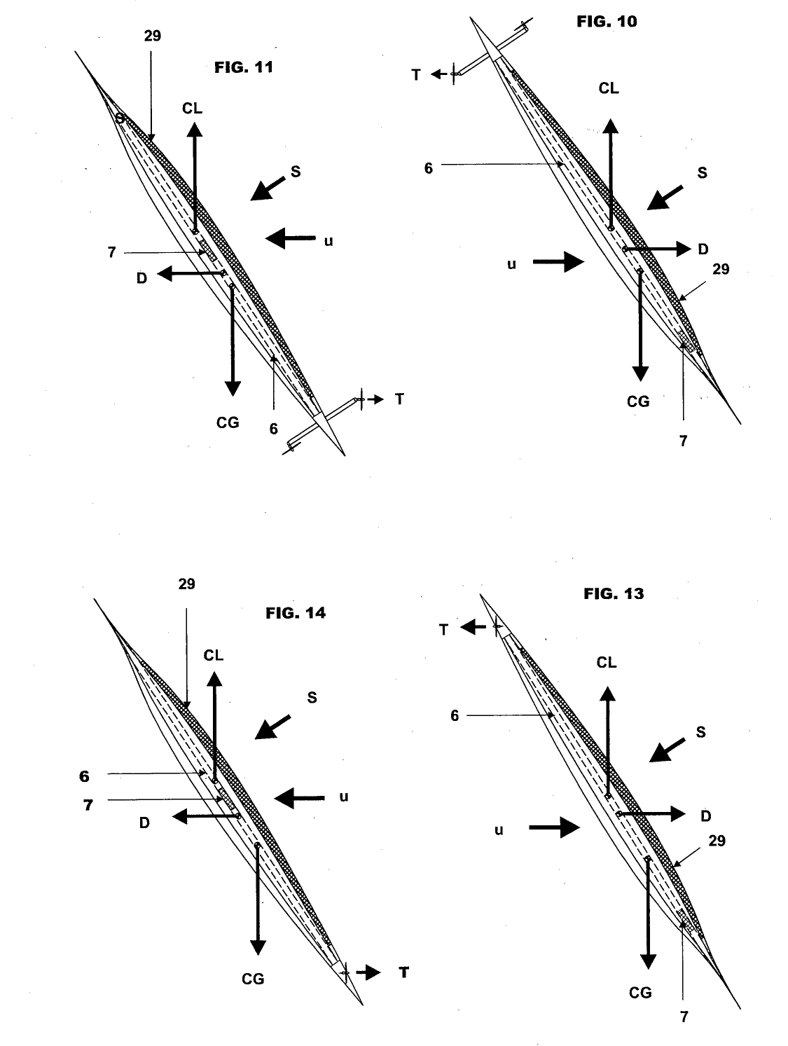

FIG. 10, 11 present the craft of FIG. 8 as its pitch equilibrium angle is tuned in order to form a corner in relation with the horizon, in order for the solar arrays mounted on its outer surface to be oriented towards the sun flux, while the two thrust application points define a straight line normal to a plane which intersects vertically the level of the horizon.

FIG. 12, 13, 14 present the craft of FIG. 8 as its pitch equilibrium angle is tuned in order to form a corner in relation with the horizon, in order for the solar arrays mounted on its outer surface to be oriented towards the sun flux, while the two thrust application points define a straight line of parallel orientation with the level of the horizon.

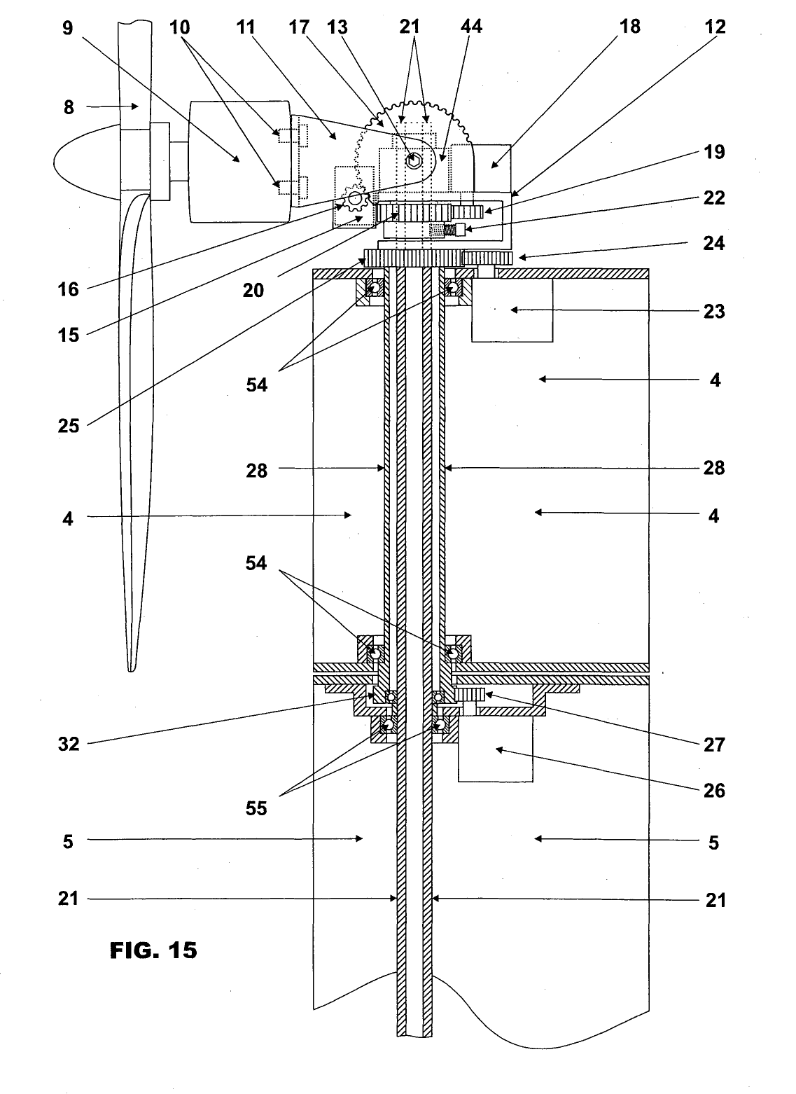

FIG. 15 presents in side view of the one of two thrust units, its neighboring flap, and a segment of a flap located between the thrust units neighboring flap and the crafts hull as well as elements corresponding to the attachment of all the above on a rod through which the provided powers are transferred to the craft.

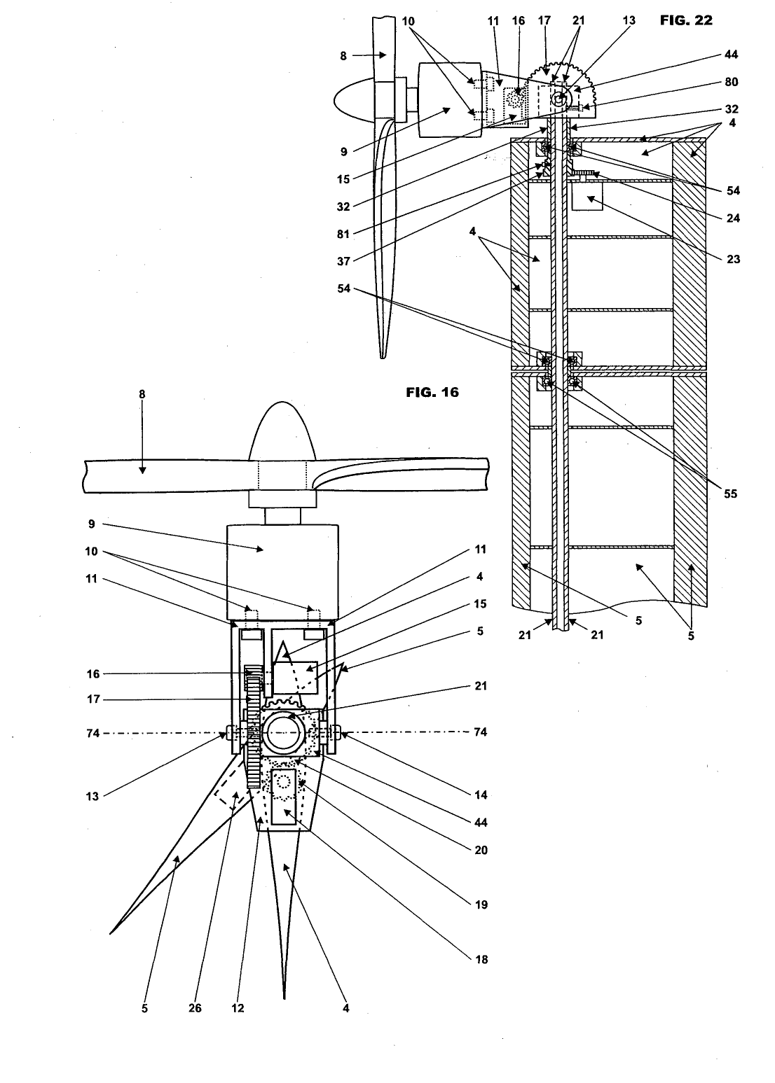

FIG. 16 presents top view of FIG. 17.

FIG. 17 presents method of connecting sections A and B of the craft in a manner such as to enable relative rotation between them.

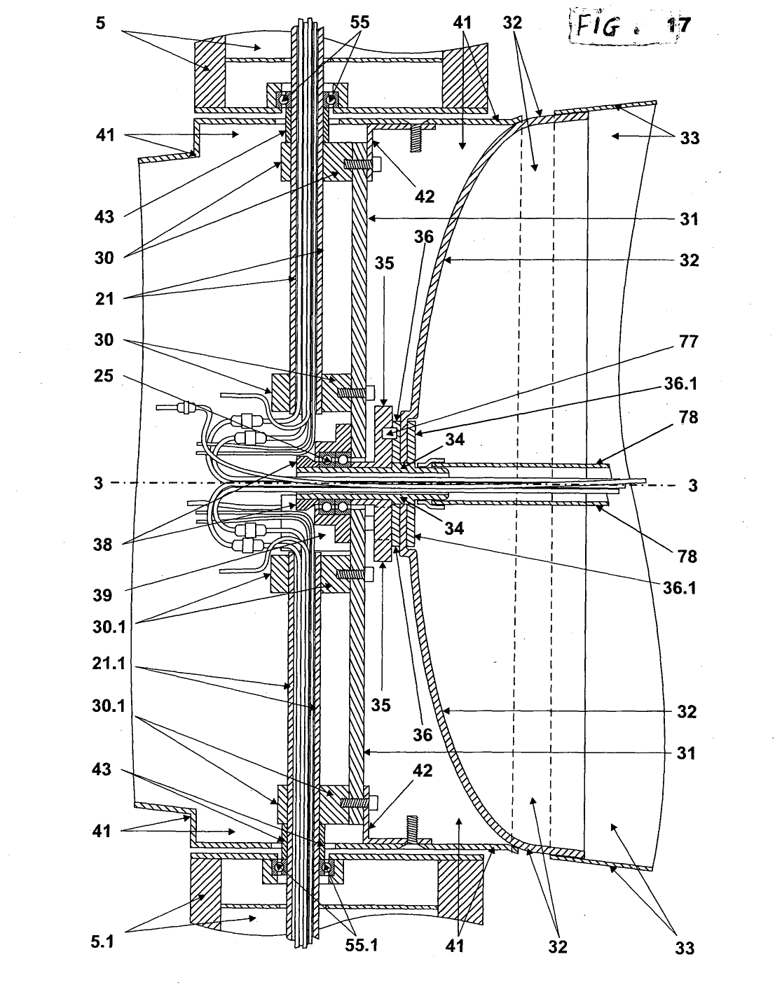

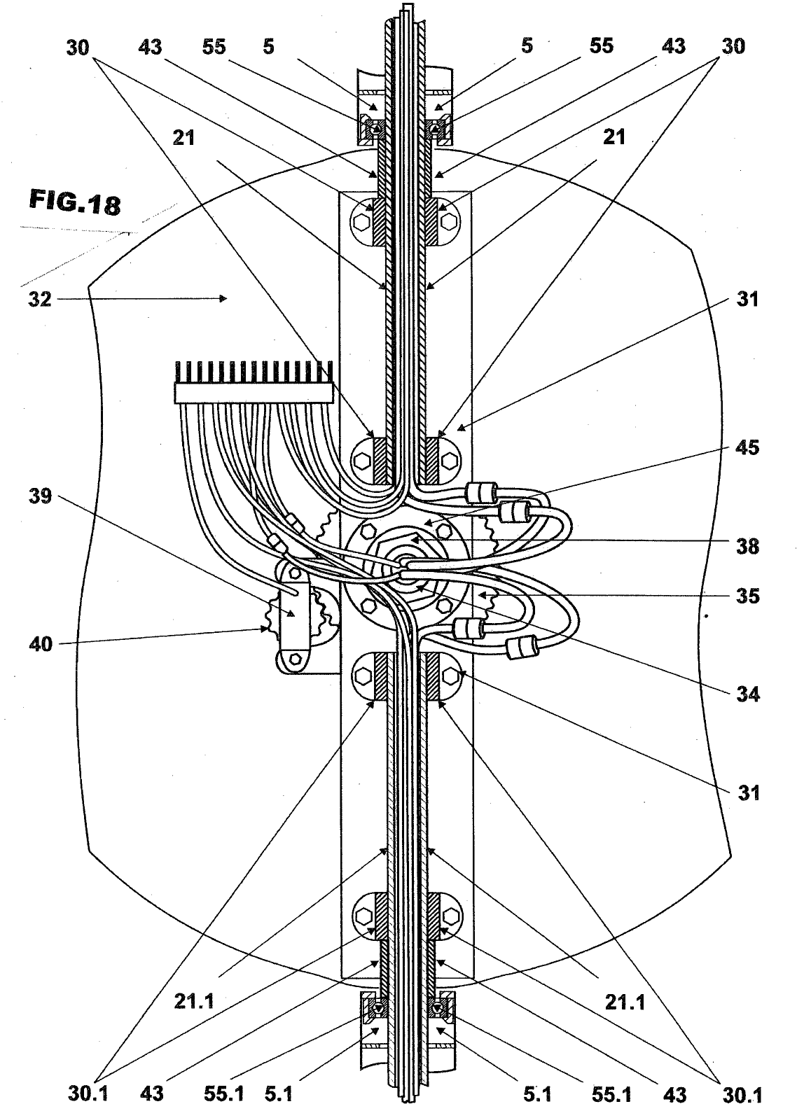

FIG. 18 is a perspective view of the FIG. 17.

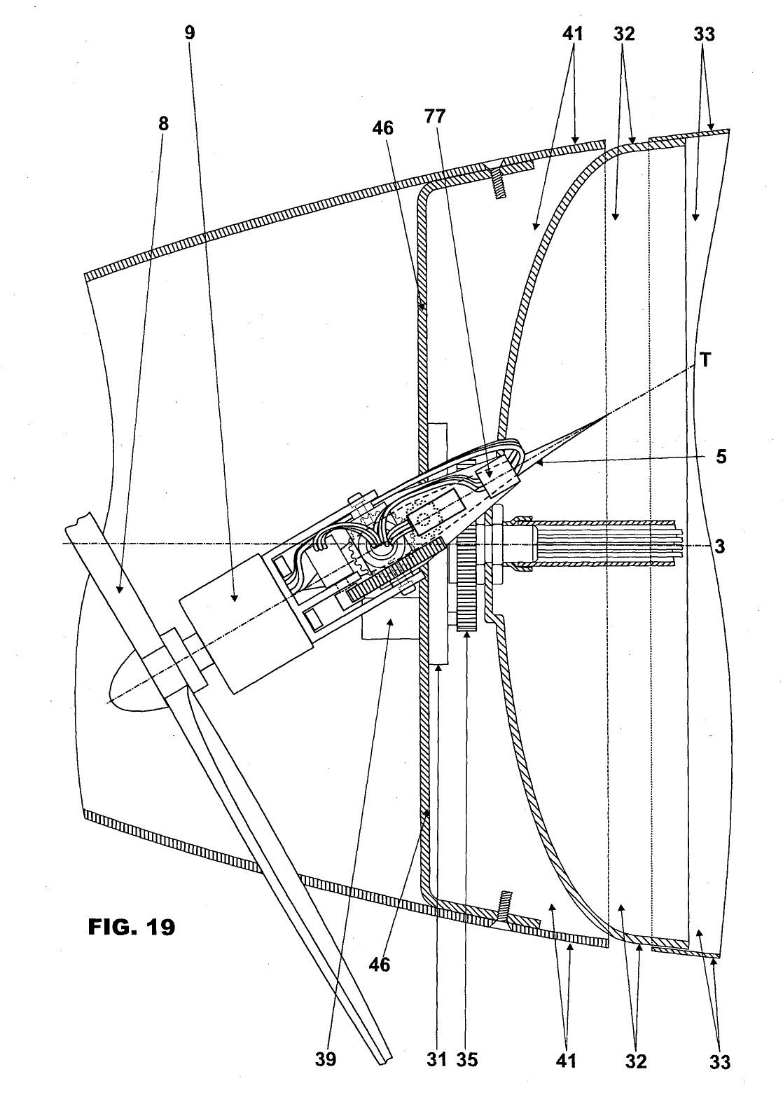

FIG. 19 is top view of the thrust unit 20 in a position such as to provide the thrust, the axis of which is at an angle in relation to the craft's longitudinal axis.

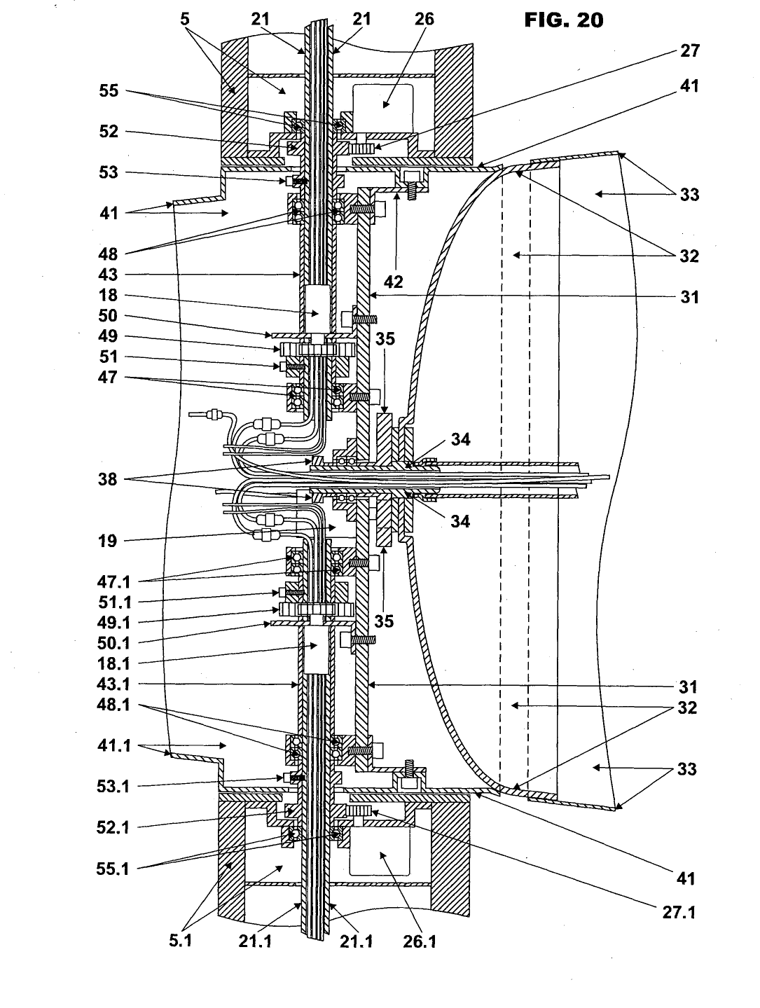

FIG. 20 presents' in side view alternative architecture section of the craft whereby servomotors (18), (18.1) by means of which the rotation of units thrust o about an axis which coincides with the plane defined by the axis of symmetry craft and since they thrust axes are oriented parallel to the axis of symmetry are located in position such that each acts to its respective connecting rod of each thrust unit with the hull of the craft.

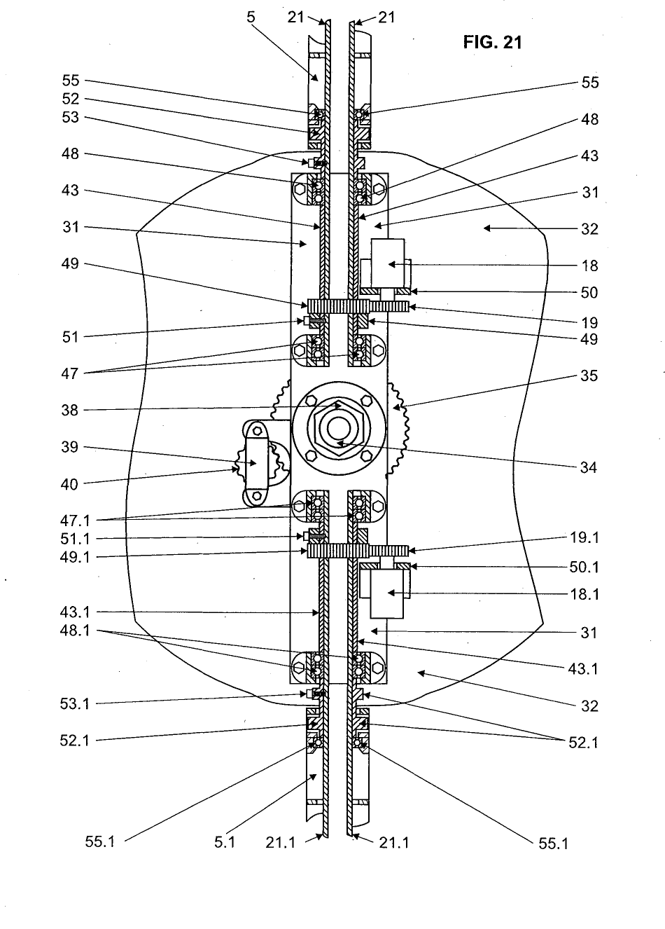

FIG. 21 is presents a front view of FIG. 20. A detailed description of the attached figures, with references on their numbering follows.

FIG. 1 presents a craft manufactured according to the present application in which thrust units (2) (2.1) are attached to the crafts hall through link rods (21), (21.1) which are presented in subsequent designs. Also presented are fins (4), (4.1), (5), (5.1) and the hull of the craft (1). The elements (2), (4), (5) are located in positions diametrical opposite in relation to the crafts longitudinal axis (3) with the elements (2.1), (4.1), (5.1), respectively. For ease of understanding the plans of this application, the position shown in FIG. 1 will be marked as side view.

FIG. 2 is a top view of FIG. 1.

In FIG. 3 presents front view of FIG. 1 wherein the craft is shown in position around its roll axis such that the propulsion units to define a straight line which intersects vertically the level of the horizon. It also presents the hull of the craft (1) fins (4), (4.1), (5), (5.1) suspended on support bars (21), (21.2) which will be obvious in next figures and propellers (8), (8.1).

FIG. 4 is a perspective view of FIG. 1 wherein the craft is shown in a position in the roll axis such that the propulsion units define a line which lies at a position parallel to the horizon. It also presents the hull of the craft (1) fins (4), (4.1), (5), (5.1) suspended on support bars (21), (21.2) which will be obvious in next figs and propellers (8), (8.1).

FIG. 5 presents a craft hull (1) which is rotationally symmetric to axis. Also presents the craft's thrust units in different possible positions, so that the thrust generated by those, presented with arrows, to control the direction of the craft in the plane defined by the thrust units and the craft's axis of symmetry.

FIG. 6 presents a side view of FIG. 5 presents the thrust units at various angles around the axis of the connecting rod, so that the thrust generated by those which presented with arrows, to help to control the direction of the craft in the plane perpendicular to this defined by the support bars and the axis of the craft.

In FIG. 7 is presented with a dashed line a desired course of the craft from point A to point B which craft is shown in three positions. Points A and B where providing thrust from the power units are sized as well and at an angle relative to the longitudinal axis of the craft such that the craft is stationary overcoming the effect of free flow (u). At point D, the craft is shown in a position such that the resultant of Drag and thrust forces results in movement from point A to point B. The angle of the axis of symmetry (V) in relation to the desired course depends on:

A. The speed of the free flow (u) relative to the level of humidity, density and temperature of the fluid.
B. The angle of the free flow (u) with respect to the desired course.
C. The fluidic resistance presented by the craft in accordance with its design.

FIG. 8 presents a craft which consists of two parts A and B, where A is a part localized to the craft's front portion which, according to this application is bounded between the extreme front of the craft and the point of application of Drag (D) brought on craft from the surrounding stream flow (u) when it's axis is parallel to the axis of the craft and the direction from the front to part towards the back and wherein the B segment of the craft which is limited by the extension of the section A to the back end of the craft and is axially symmetric about its longitudinal axis. Featured units are available (2) (2.1) provide thrust (T) solar collector surface (29) which is firmly attached to part B of the craft and part (6) inside the section B in which can move load (7) along an axis which is parallel or coincident of the axis of symmetry of the portion B. By this movement is achieved by the displacement of the center of gravity (CG) with respect to the center of lift (CL) in the longitudinal axis of the craft, which function the sole aim and use is the determination of the craft's equilibrium pitch angle so as to permit the proper orientation in the above axis, closely adapted to this system. The arrow (5) illustrates the direction of the solar radiation. The movement of the load (7) is achieved by means of a transmission from a servomotor inside an appropriate configuration of the interior (6). In the present fig. the load (7) locates in a position such that the (CL) and (CG) coincide that the craft is maintained at a position parallel to the horizon. The element (41) is RCLK cover elements that make up the part of the craft.

FIG. 9 shows the front view of FIG. 7 clearly visible the parts A and B, the relative rotation between which, if through the drives, (2), (2.1) and fins (4), (4.1), (5) (5.1) ensures a certain corner of part A about the roll axis, ensuring part B certain corner along the roll axis such that the solar energy collection system (29) firmly attached on it, to be efficiently oriented towards the solar flux (5). For this operation to be feasible, according to the design, it is necessary the part's B center of gravity to coincide with its center of lift.

FIG. 10 presents a craft manufactured according to the present application in side view. The thrust application points upon the linking rods define a plane perpendicular to the horizon. Thrust is provided by one of the two units which locates closer to the incoming external flow (u). On the surface of the craft is firmly attached a solar array (29). Also the load (7) have been moved to the rear of the craft so that the center of gravity (CG) is located closer to the rear of the craft in comparison with the center of lift (CL) resulting in the success of appropriate angle of the craft around the pitch angle for the solar arrays to be oriented towards the solar flux (S). The pitch equilibrium state is tuned from the movement of the load (7) towards the rear of the craft results in the craft to rotate about an axis which intersects the vertical plane defined by the points of application of the thrust forces from the thrust units to the connecting rods and the axis of the craft. The craft's pitch equilibrium state depends upon:

A. The position along the longitudinal axis of the point of application of the resultant of forces according to the design of the craft in relation to the surrounding flow's angle of attack.
B. The distance between the center of gravity (CG) and the center of buoyancy (CL).
C. The distance from the points of application of the above from the thrust force's application center.
D. The speed of the surrounding flow (u)
E. The characteristics of the ambient fluid.
F. The size of the drag (D) presented by the craft in accordance with its design.
G. The corner of the provided thrust.

The movement of the load (7) into (6) is achieved by servomotor which receives commands from computing unit in accordance with sensors for determining the angle of the solar flux (S) in relation to the craft's longitudinal axis in order for the best possible angle between the solar flux (S) and the solar array (29) to be achieved.

FIG. 11 presents a craft as detailed in FIG. 10 oriented in a manner such that the modules (29) are oriented in the direction of solar radiation (5) which in this plan differs from that presented in the FIG. 10. In this plan the load (7) has moved closer to the front of the craft.

FIG. 12 presents the craft of FIG. 8 with the corresponding numbering for the items presented in a position such that the line defined by the thrust application points is parallel to the horizon. In this design the load (7) is located in a position such that (CL) and (CG) coincide so that the craft is maintained in a position parallel to the horizon.

FIG. 13 presents craft of this application in such a position that the thrust application points define a line parallel to the horizon. The craft according to what is described in FIG. 10 is oriented in such a way that the solar array (29) is oriented towards the solar flux (5). In this design the load (7) has been moved closer to the rear portion of the craft.

FIG. 14 presents a craft in such a position that the thrust units are in level parallel to the horizon. The craft according to what is described in FIG. 10 is oriented in such a way that the solar arrays (29) are oriented towards the solar flux (S). In this design the load (7) has been moved closer to the front of the craft.

FIG. 15 presents all the components that are attached on the connecting rod (21) as follows: motor (9) the axis of which is firmly attached propeller (8). The motor (9) is firmly attached by screws (10) on element (11) which is mounted through the axles (13), (14) at element (44) in such a way as to allow rotation in relation to the element (44), with axis of rotation (74) defined by the connecting elements (13) and (14). The previous mentioned (74) and (14) are presented in FIG. 16. On the element (11) is firmly attached a servo motor (15) on the shaft of which is firmly mounted a gear (16) which, according to the design of the system is in mesh with gear (17) which is firmly attached to the element (44), in a concentric position with the connection elements (13) and (14) in a manner such that the rotation of the gear (16) from the servomotor (15) to drive in rotation the element (11) relative to the element (44) resulting the change in the angle of attack of the propeller (8) in order thereby the achievement of direction change of the thrust provided by it, normal to plane perpendicular intersecting from the line defined by the longitudinal axes of the elements (13), (14). The element (44) is mounted on the rod (21) in such a way as for its rotation around it to be possible. The elements (44) position along the rod (21) is limited by element (20) which is firmly mounted on the rod (21) towards the craft and of any kind of ring shaped element fixed by any means on the rod (21) towards the opposite direction. On (44) is firmly mounted element (12) on which lies firmly attached servo motor (18) on the shaft of which is firmly mounted gear (19). The servomotor (18) is attached to the element (12) in a manner and in such a position that the gear (19) is in mesh with a gear (20) which is firmly attached to the connecting rod (21) via the screw (22). The rotation of the gear (19) by the servomotor (18) results in the rotation of the elements (12), (44), (11), (9) and hence the change in the angle of attack of the propeller (8) with resulting in the change of direction of the thrust is obtained normal to a plane which is perpendicularly intersected by the connecting rod (21). The flap (4) is adapted to the rod (21) via ball bearings (54) in order for its rotation around the rod (21) to be possible. Within the fin (4) a servomotor (23) is fixed, on the axis of which a gear (24) is firmly mounted, which is in mesh with a gear (25) which is firmly attached in a collinear manner to the element (12) as for the gear (25) center to coincide with the element's (12) center of rotation around the connecting rod (21). The above mentioned results on the fact that the rotation of the servomotor's (23) shaft drives the gear (24) in motion around the gear (25) resulting to the rotation of the flap (4) around the axis of the rod (21). In any case that the servomotor (23) is in stationary state, the rotation of the element (12) by the servomotor (18) drives in rotation, through the gear (25), the flap (4). Also shown cross section of element (28) which is of cylindrical shape of internal diameter greater than the of the rod's (21) outer diameter. The element (28) firmly attached to the element (12) or the gear (25) so that through the element (28) rotary motion is transferred to gear (27) which is fixed on servomotor (26) which is firmly mounted within the fin (5). On the servomotor's (26) axle a gear (27) is mounted, which is in mesh with gear (32) in a manner such that rotation of the shaft, through the transmission of motion from the gear (32) towards the gear (27) to drive in rotation the fin (5) around the axis of the connecting rod (21). The gear (32) is firmly attached to the element (28). Whereas the servomotor (26) is at standstill, the rotation of the element (12) by the servomotor (18) is transmitted to the flap (5) through the elements (28), (32), (27) and (26) driving it in rotation. The adjustment of the flap (5) on the connecting rod (21) is achieved via bearings, one of which (55) is presented in this fig. Primary use of the flap (5) is the aerodynamic cover of the connecting rod (21) and secondary the contribution to the crafts control in a plane perpendicular of the straight line determined by the propulsion units. The flap (5) is not surrounded by the thrust flow but by the free flow. Since the thrust shafts and free flow in many cases do not coincide, although through rotation of the element (12) and if the servomotor (26) is at rest the flap (5) will pass a position such that the fins will provide the minimum possible flow resistance. Through the rotation of the servomotor (26) the success of the optimal angle of the flap (5) achieved in relation to the free stream. The servomotor (26) through the proper commands rotates the fin in such a position through which, according to data from sensors which determines the fin's angle of attack in relation to the free flow, it will provide the minimum possible drag.

FIG. 16 is a top view of FIG. 15 referring to the corresponding numbered elements shown therein. The fins (4) and (5) are presented to a different position between them around the connecting rod (21).

FIG. 17 presents a side view of sections of segments A and B and specifically part of the hull (33) in the front part of which the element (32), made of a material harder than of the hull's in order to comprehend the adaption of the segment A. At element (32) fits firmly the element (34) which is cylindrical and a part of its outer surface is formed as a thread in order for the element (32) to be clamped between nuts (36), (36.1) making thus possible a firm connection of the elements (32) and (34). The element (32) through which passes the element (34) located at a point such that the longitudinal axis of the element (34) coincides with the craft's longitudinal axis (3). Among the nuts (36), (36.1) and element (34) if for the benefit of the hull's sealing if required may be inserted materials suitable for this purpose (not shown in this figure). Also shown in cross section element (35) which is a gear in the center of which a bore is formed of diameter such as to make possible the application of the element (34). By adjusting the elements (34), (32) between them taken that the nut comes into contact with the gear (35) having a specific position around the element (32) and hence the longitudinal axis of the craft so that through pin (77) which is inserted between (35) and (36) to ensure specific angle for (35) about the longitudinal axis so as to enable the operation which will be described further below. On the opposite side thereof facing the nut, the gear (35) has on its outer surface configuration which serves as spacer of length such that at the full tightening to that of the inner ring of the bearing (25) of the nut (38) no parts mounted on bearings (25) may come into contact with the elements (35), (36), (32) and (33). On bearings (25) fits the element (31) on which, through links (30) and (30.1) rods (21) and (21.1) fits respectively, which links the forces from the thrust systems (2), (2.1) and the fins (4), (4.1), (5), (5.1). On the element (31) a servomotor (39) is mounted in position such that gear (40) rigidly mounted on its shaft (shown in FIG. 18) to be in mesh with the gear (35) in a manner such that rotation of the shaft of the servomotor (39) to lead to the relative rotation of the elements (31) and (34) around the longitudinal axis of the element (34). On element (31) is mounted via links (42) element (41) which is a streamlined cover and touching the element (32) so as to present the least possible resistance but in a loose way such that the rotation of (31) around the shaft (34) is permitted. The element (31) and all elements that directly or indirectly adapted to this are elements of the craft's part A. The element (34) may be hollow so that through its cavity cables or pipes may pass through which may be transferred from section B to A and vice versa fluids (fuel for thermal engines), voltage (for motors), data from sensors, commands towards any kind of actuators or the surrounding fluid in order to cool elements of part B (such as batteries, electronics, etc.). For sealing the interior of the envelope (33) all elements of part B for which a connection with section A of the craft or the external environment surrounded by element (78), which makes it possible to seal the interior of (33).

FIG. 18 is the front view of FIG. 17 against which the elements (35), (39) and (40) are presented more clearly.

FIG. 19 is a top view of FIG. 17 with the difference over it that the thrust unit appears rotated so that the axis of thrust (T) provided on an angle such us to intersect the plane defined by the longitudinal axis of the craft (3) and the straight line defined by the thrust application points from the thrust units towards to their connecting rods.

FIG. 20 is a side view of an alternative construction architecture of section A in which the connecting bars (21), (21.1) adapted to the element (31) via bearings (47), (48) and (47.1), (48.1) respectively in such a manner that the actuators (18), (18.1) by means of which the rotation of the thrust units around the connecting rods longitudinal axis. The servomotors (18), (18.1) firmly adapted on (31) through connectors (50) and (50.1) in a manner and in such a position that gears firmly mounted to their axles are in mesh with gears (49) and (49.1) respectively. The gears (49) and (49.1) firmly adapted to the connecting rods (21) and (21.1) by means of screws (51) and (51.1). Between gears (49),(49.1) and connecting rods inserted elements (43), (43.1) on the surface of which holes are formed through which the screws (51), (51.1) pass, in such a way as to insure certain position of the connecting rods between the bearings. On connecting rods adapted firmly elements (52), (52.1) by means of screws (53), (53.1). The elements (52), (52.1) is of sufficient length to those defined distance between the bearings (48), (55) and (48.1), (55.1) respectively so as to ensure a certain distance of the fins (5), (5.1) from the the craft's axis of symmetry. The bearings (55) and (55.1) are adapted between the fins (5), (5.1) and the connecting rods (21), (21.1) respectively. Parts of the outer surface of the elements (52), (52.1) are configured as gears which are in mesh with the gears (27), (27.1) which are firmly attached to servomotors (26), (26.1), respectively, which are mounted inside the fins (5), (5.1).

FIG. 21 is front view of FIG. 20 which presents the information contained with their corresponding numbers.

FIG. 22 presents in side view data of section A between the thrust unit (2) and connecting rod (21) in accordance with the alternative architecture shown in FIGS. 20 and 21. Specifically shown the motor (9) in the axis of which is firmly attached a propeller (8). The motor (9) is firmly attached by screws (10) on element (11) which is mounted through the axles (13), (14) at element (44) in such a way as to allow rotation in relation to the element (44), with axis of rotation (74) defined by the connecting elements (13) and (14). The previous mentioned (74) and (14) are presented in FIG. 16. On the element (11) is firmly attached a servo motor (15) on the shaft of which is firmly mounted a gear (16) which, according to the design of the system is in mesh with gear (17) which is firmly attached to the element (44), in a concentric position with the connection elements (13) and (14) in a manner such that the rotation of the gear (16) from the servomotor (15) to drive in rotation the element (11) relative to the element (44) resulting the change in the angle of attack of the propeller (8) thereby the achievement of direction change of the thrust provided by it, normal to plane perpendicular intersected from the line defined by the longitudinal axes of the elements (13) and (14). The element (44) is firmly mounted on the rod (21) through screw (80) so that the rotation of the rod (21) from the servomotor (18), presented earlier in FIG. 20, results to the change of the direction of the thrust provided by the propeller (8). The motor (9) is firmly attached by screws (10) on element (11) which is mounted through the axles (13), (14) at element (44) in such a way as to allow rotation in relation to the element (44), with axis of rotation (74) defined by the connecting elements (13) and (14). The previous mentioned (74) and (14) are presented in FIG. 16. On the element (11) is firmly attached a servo motor (15) on the shaft of which is firmly mounted a gear (16) which, according to the design of the system is in mesh with gear (17) which is firmly attached to the element (44), in a concentric position with the connection elements (13) and (14) in a manner such that the rotation of the gear (16) from the servomotor (15) to drive in rotation the element (11) relative to the element (44) resulting the change in the angle of attack of the propeller (8) in order thereby the achievement of direction change of the thrust provided by it, normal to plane perpendicular intersecting from the line defined by the longitudinal axes of the elements (13), (14). Also occurs flap (4) in which is firmly mounted servomotor (23) in a manner such that gear (24) firmly attached to its shaft is in mesh with gearing section of element (37) through which the screw (81) is firmly attached the rod (21). The rod (21) passes through the center of the geared portion of the element (37) so that rotation of the servomotor (23) or the rotation of the connecting rod (21) since the servo (23) is at a standstill to drive in rotation about the axis of the rod (21) the flap (4). Between the element (44) and the bearing (54) which is interposed between the flap (4) and the connecting rod (21) inserted element (32) acting as a spacer, ensuring specific distance between the element (44) and the fin (4). Between the flap (5) and the rod (21) inserted bearings, one of which the end towards the flap (4) numbered (55) shown in this fig. Between the bearings (55) and the bearing (54) locates spacer through which ensures proper distance between the fins (4) and (5) to allow the relative rotation between them.

1-13. (canceled)

14. A neutral buoyancy craft comprising:
a first control system that produces forces relevant to stability, guidance, navigation and control functions; and
a hull including two segments, a first segment onto which all produced forces generated by the first control system are exclusively applied and which is located ahead, towards the hull's bow, from a second segment within which the Drag application center (center of pressure) of the craft is located.

15. The neutral buoyancy craft of claim 14, wherein the first control system includes a thrust system comprised by at least two thrust units disposed on opposite ends about a longitudinal axis defined by the hull.

16. The neutral buoyancy craft of claim 15, wherein the first control system further comprises link rods configured to transfer thrust produced from the at least two thrust units to the first segment, each thrust unit is connected on a corresponding link rod through a double hinge system to thrust vector around two axes perpendicularly intersecting each other.

17. The neutral buoyancy craft of claim 16, wherein the first control system further comprises a plurality of fins coupled to the link rods.

18. The neutral buoyancy craft of claim 14, further comprising a second control system configured to produce rotational forces for independently rotating the second segment from the first segment without affecting stability, guidance, navigation and control.

19. The neutral buoyancy craft of 18, wherein the first and second segments rotate independently relative to one another about a longitudinal axis defined by the hull.

20. The neutral buoyancy craft of claim 19, wherein a shape of an outer surface of the second segment is a shape of revolution around an axis onto which axis the centers of gravity and lift center of lift of the second segment are located.

21. The neutral buoyancy craft of claim 20, wherein rotational forces generated by the second control system are transferred between the first and second segments in a manner that adjusts the roll angle of the second segment about the longitudinal axis to move the second segment into a desired direction.

22. The neutral buoyancy craft of claim 21, wherein the adjustment of the roll angle in a desired direction positions the second segment such that equipment attached on or in the second segment is selectively positioned.

23. The neutral buoyancy craft of claim 22, wherein the equipment includes solar panels, and the selective positioning involves positioning the solar panels in an optimum position in relation to the solar flux.

24. The neutral buoyancy craft of claim 22, wherein the first control system includes a thrust system comprised by at least two thrust units disposed on opposite ends about a longitudinal axis defined by the hull, where the control system further comprises link rods configured to transfer thrust produced from the at least two thrust units to the first segment, and wherein the control system further comprises a plurality of fins coupled to the link rods.

25. A method of maneuvering a neutral buoyancy craft of the type including a control system that produces forces relevant to guidance, navigation and control functions, and which includes a thrust system comprised of at least two thrust units disposed on opposite ends about a longitudinal axis defined by a hull, the control system including fins coupled to link rods configured to transfer thrust produced from the at least two thrust units, the hull including a first segment onto which the produced forces are exclusively applied and a second segment within which a Drag's application center (center of pressure) of the craft is located, the hull further having a mechanism that controls the control system, the method comprising:
identifying a need to adjust the navigational path of the neutral buoyancy craft;
identifying the commands to cause the control system to produce the relevant forces; and
transmitting the commands to the control system.

26. The method of claim 25, wherein the identifying the commands includes identifying environmental conditions and flight relevant information and on the basis thereof generate pilot control signals configured to control motors and fins actuator systems to achieve thrust control, roll control, yaw control, and pitch control.

27. The method of claim 26, where the pilot control signals adjust thrust, roll, yaw and pitch according to a desired mode of navigation control, where the desired mode of navigation control includes at least two modes of navigation control.

28. The method of claim 27, wherein the at least two modes of navigation control include:
(a) a first mode where the equilibrium roll angle of the first segment is such that the control motors define an axis that is parallel to the plane of the horizon,
(b) a second mode where the equilibrium roll angle of the first segment is such that the control motors define an axis that is perpendicular to a plane defined by the horizon,
(c) a third mode where the equilibrium roll angle of the first segment is such that the control motors define an axis that is perpendicular to a plane that is in turn defined by the longitudinal axis of the hull and the axis defined by the surrounding flow direction,
(d) a fourth mode where the equilibrium roll angle of the first segment is such that the control motors define an axis that is parallel to the plane of the horizon and the equilibrium pitch angle is tuned in corner in respect to the horizon for the achievement of the best possible orientation of systems firmly attached on the second segment, and
(e) a fifth mode where the equilibrium roll angle of the first segment is such that the control motors define an axis that is perpendicular to a plane defined by the horizon and the equilibrium pitch angle is tuned in corner in respect to the horizon for the achievement of the best possible orientation of systems firmly attached on the second segment

29. The method of claim 28, wherein the at least two modes includes all five modes.

30. The method of claim 29, wherein in the first mode:
thrust is generated from both thrust units,
roll control is achieved either by moving fins in a particular direction or by controlling thrust direction, roll control via the fins occurs when rotating the fins for a given level of external speed flow is such as to be able to create a roll moment, else roll control is achieved by controlling thrust direction,
pitch control is achieved through either unidirectional rotational control of the fins for a given level of external speed flow is such as to be able to create a pitch moment, else pitch control is achieved by controlling unidirectional rotation of the thrust units, and
yaw control is achieved by first performing roll control until the axis defined by associated thrust points is perpendicular to a plane that is defined by the longitudinal axis of the hull and the desired direction of travel, and then performing pitch control toward the desired direction of travel.

31. The method of claim 28, wherein in the first mode:
thrust is generated from both thrust units,
roll control is achieved either by moving fins in a particular direction or by controlling thrust direction, roll control via the fins occurs when rotating the fins for a given level of external speed flow is such as to be able to create a roll moment, else roll control is achieved by controlling thrust direction,
pitch control is achieved through either unidirectional rotational control of the fins for a given level of external speed flow is such as to be able to create a pitch moment, else pitch control is achieved by controlling unidirectional rotation of the thrust units, and
yaw control is achieved by first performing roll control until the axis defined by associated thrust points is perpendicular to a plane that is defined by the longitudinal axis of the hull and the desired direction of travel, and then performing pitch control toward the desired direction of travel.

32. The method of claim 31, wherein the link rods are configured to transfer thrust produced from the at least two thrust units to the first segment, and wherein the first and second segments are configured to rotate independently relative to one another about the longitudinal axis defined by the hull.

33. The method of claim 31, wherein a shape of an outer surface of the second segment is a shape of revolution around an axis onto which axis a center of gravity and center of lift of the second segment is located.
